(19) United States
(12) Patent Application Publication
(10) Pub. No.: US 2005/0133073 A1
(43) Pub. Date: Jun. 23, 2005

(54) Substrate carrier for receiving and retaining in position a planar element

(76) Inventor: Thomas Krieg, Solms (DE)

Correspondence Address: Michael L. Dunn;Simpson & Simpson, PLLC, 5555 Main Street, Williamsville, NY, 14221-5406, US

(21) Appl. No.: 11/012,454

(22) Filed: Dec. 15, 2004

(30) Foreign Application Priority Data
Dec. 19, 2003 (DE) DE10359732.8

(51) Int. Cl. B66C 1/42

(52) U.S. Cl. 134/105; 414/200; 294/119.1

(57) ABSTRACT

A substrate carrier (20, 30, 40, 50) for receiving and retaining a planar element in position. At least one plastic support (25) is provided on the substrate carrier, and the planar element is held exclusively by means of adhesion.

### CROSS REFERENCE TO RELATED APPLICATIONS

This application claims priority of the German patent application 103 59 732.8, filed Dec. 19, 2003, which is incorporated by reference herein.

### FIELD OF THE INVENTION

The invention concerns a substrate carrier for receiving and retaining in position a planar element.

### BACKGROUND OF THE INVENTION

In semiconductor production, wafers are sequentially processed in a plurality of process steps during the production process. With increasing integration density, demands in terms of the quality of the features configured on the wafers, and in terms of secure wafer handling, are rising. “Handling” is understood to mean the transfer of a wafer from one station to the next. Substrate carriers are indispensable resources for temporary holding and retention in position for mechanical processing, cleaning, and inspection of semiconductor substrates in microelectronics and optoelectronics technology. In the case of substrates produced on an industrial scale, the carriers are usually disk-shaped.

At present, the substrates to be processed are adhesively bonded onto the substrate carriers or, if the carrier is appropriately configured, are held in place by negative pressure (a vacuum).

German unexamined Application 44 25 874 discloses a substrate carrier for receiving and temporarily retaining a planar element in position. Retention of the planar element is achieved with vacuum. For that purpose, the contact surface has a plurality of openings through which the negative pressure acts on the planar element.

U.S. Pat. No. 6,563,195 discloses a carrier for a wafer having a dust-protection film. For transport, the wafer rests on silicone rubber. Before placement, a protective film provided on the silicone rubber is removed. This patent also does not disclose the use of a plastic for the various handling systems for a wafer.

### SUMMARY OF THE INVENTION

It is the object of the invention to create a universally usable and easily handled substrate carrier with which retention of substrates is possible in simple fashion. Transport of the substrate in any desired direction and position in space is also intended to be possible.

This object is achieved by way of a substrate carrier, for receiving and retaining a planar element in position, comprising at least one plastic support provided on the substrate carrier; wherein the planar element is held exclusively by means of adhesion.

It is particularly advantageous if at least one plastic support is provided on the substrate carrier; and that the planar element is held exclusively by means of adhesion. Advantageously, the substrate carrier can be a pull-out finger for a planar element or a semiconductor substrate. The substrate carrier can also be a changer for a planar element or a semiconductor substrate. A wafer chuck for a planar element or a semiconductor substrate is likewise conceivable as the substrate carrier. Lastly, the substrate carrier can be an end effector (end/edge holder) for a planar element or a semiconductor substrate. The plastic support is made of an elastomer or a thermoplastic.

It is particularly advantageous if the plastic support on the substrate carrier is subdivided into several individual plastic supports, the plastic supports together forming an overall surface which is calculated in such a way that the adhesion forces are sufficient to hold the planar element. The overall surface of the plastic supports for the planar element is calculated as a function of the diameter and the weight of the planar element.

### BRIEF DESCRIPTION OF THE DRAWINGS

The subject matter of the invention is depicted schematically in the drawings and will be described below with reference to the Figures, in which:

FIG. 1 schematically depicts the configuration of the complete system for handling wafers;

FIG. 2 depicts, in perspective, a pull-out finger for semiconductor substrates or wafers;

FIG. 3 depicts, in perspective, a changer for semiconductor substrates or wafers;

FIG. 4 depicts, in perspective, a wafer chuck for semiconductor substrates or wafers; and

FIG. 5 depicts, in perspective, an end effector for semiconductor substrates or wafers.

### DETAILED DESCRIPTION OF THE INVENTION

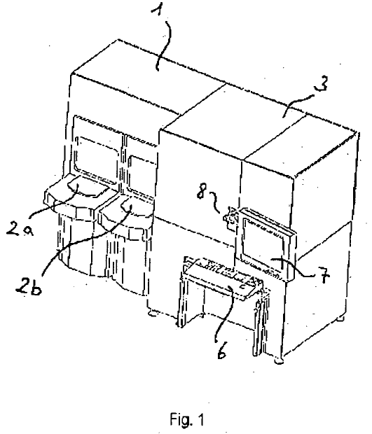

FIG. 1 shows, by way of example, a three-dimensional view of a substrate delivery module 1 and workstation 3. Two transfer stations 2a, 2b for the substrates are associated with the substrate delivery module. This overall external view also shows a monitor 7 with which the user can check his inputs made via operating interface 6, track the status of substrate handling, or view results of the work processes in workstation 3, etc. Images of the substrate can also be displayed on monitor 7 in the event a camera is installed in workstation 3, or the substrate can be observed directly with a microscope via a microscope viewing port 8. During examination or treatment, the substrates are transported back and forth between transfer stations 2a, 2b, delivery module 1, and workstation 3. The substrate rests on a substrate carrier (not depicted in FIG. 1).

The substrate carrier is for receiving and retaining any desired element in position, in particular a semiconductor substrate (wafer), for the manufacture of electronic or optical components on the wafer.

Retention is accomplished substantially by way of the adhesion forces that occur between the support surfaces and the substrate.

The adhesion forces that occur are proportional to the size of the support surfaces. In production processes in the semiconductor industry, substrate carriers that can retain substrates having a standardized size (at present, approximately 50 to 300 mm) are usually used. In flexible production facilities designed for smaller production runs, however, as well as facilities used for research and testing purposes, a configuration of the substrate carriers for receiving and retaining substrates of various diameters, as well as substrate fragments, is desirable.

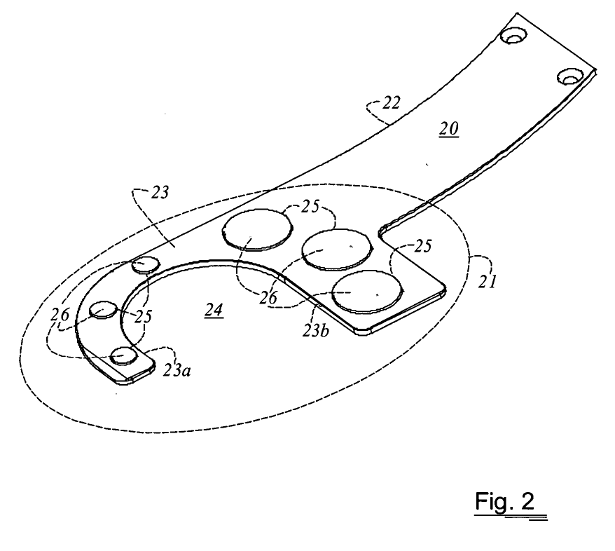

FIG. 2 depicts a pull-out finger 20 for semiconductor substrates or wafers 21 (drawn with dashed lines). Pull-out finger 20 encompasses an arm region 22 and a support region 23. Support region substantially comprises a first finger 23a and a second finger 23b. A cutout 24 is embodied between first finger 23a and second finger 23b. Arranged around cutout 24 are several plastic supports 25 that are immovably joined to first finger 23a and second finger 23b of pull-out finger 20. The plastic supports on the substrate carrier or pull-out finger 20 define in their entirety a support surface 26 for the planar element or wafer 21, that surface being determined as a function of the diameter and weight of the planar element or wafer 21.

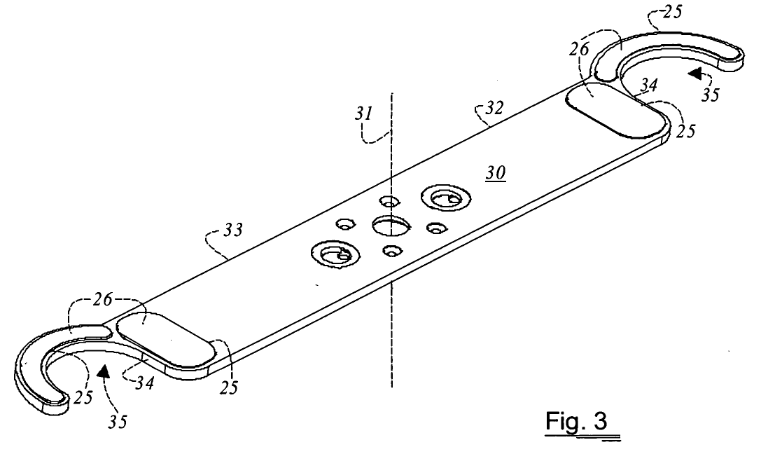

FIG. 3 depicts a changer 30 for semiconductor substrates or wafers. Changer 30 is rotatable about an axis 31 and comprises a first arm 32 and a second arm 33. First and second arms 32 and 33 are arranged at 180 degrees from one another. First and second arms 32 and 33 each have an end 34 that has a respectively configured hook-shaped protrusion 35. Protrusion 35 and end 34 each carry plastic supports 25. Corresponding to the necessary support surface 26 of plastic supports 25, the same conditions as already described in FIG. 2 apply. The embodiment of changer 30 depicted here is not to be construed as a limitation. Changer 30 can also have more than two arms.

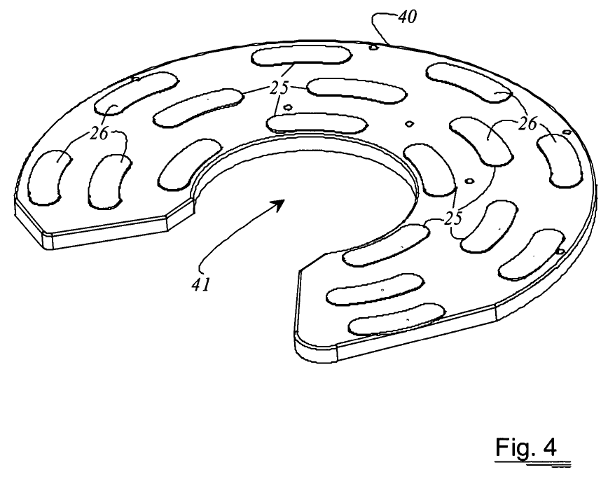

FIG. 4 depicts a wafer chuck 40 for semiconductor substrates or wafers (not shown here). Wafer chuck 40 is of annular configuration and comprises an opening by way of which a transfer of the wafer onto the wafer chuck is performed. For example, a wafer handler can be lowered through opening 41 after the wafer has been placed onto wafer chuck 40. The wafer chuck possesses a plurality of plastic supports 25. The same conditions as already described in FIG. 2 apply to support surface 26 of plastic supports 25.

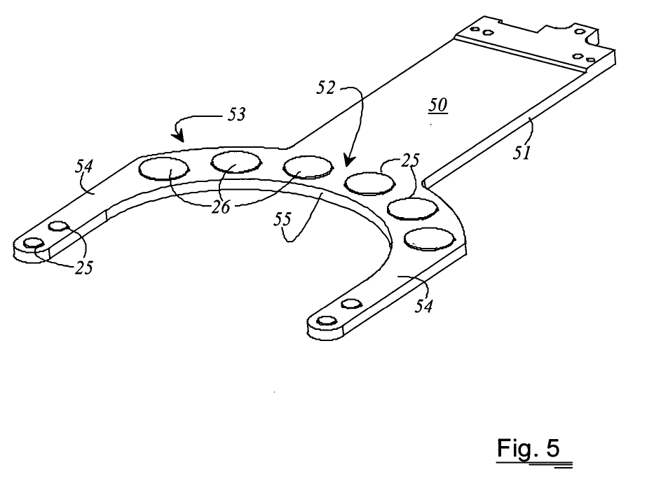

FIG. 5 depicts an end effector 50 for semiconductor substrates or wafers (not shown here). End effector 50 is mounted on a robot (not shown) that places the wafers in a magazine. End effector 50 encompasses an arm 51 that has a fork-shaped configuration 53 at one end 52. Fork-shaped configuration 53 encompasses at least two fingers 54 and a base 55. Fingers 54 and base 55 are provided with several plastic supports 25. Plastic supports 25 form support surface 26 for the wafers.

The support surfaces of the plastic supports on which the substrate or wafer rests are made of an elastomer or a thermoplastic. The thermoplastic can be embodied as soft PVC. The dust-catching mats that are used in clean rooms are one example of soft PVC. Plastic support 25 is substantially characterized by its high adhesion forces. One selected material is a soft PVC that is manufactured by the company Kager Industrieprodukte. The properties exhibited by the material were ascertained in tests. An ascertained tensile/shear strength of 0.06 N/mm² was obtained, and the tensile strength ascertained was 0.02 N/mm². These values apply to the “Weich PVC Rutschstopp” plastic that was used. It is self-evident that these ascertained values represent only a guideline. Other plastics with similar data can also be used.

As already mentioned in the description of the Figures, the necessary support surface area is obtained as a function of the diameter and weight of the wafer. If the wafer must also be safely handled upside down, the size of support surfaces 26 of plastic supports 25 must also be determined in consideration of the weight of the wafer and a requisite safety factor. When the plastic for plastic supports 25 is selected, care must be taken to avoid contamination of the wafer being handled. The plastic is either adhesively bonded, or secured to the substrate carrier with a different method (evaporatively deposited or melted on). Although four specific embodiments of a substrate carrier are depicted in the description above, the shape of the substrate carrier is arbitrary. Plastic supports 25 can likewise have any desired shape.

1. A substrate carrier for receiving and retaining a planar element in position, comprising at least one plastic support provided on the substrate carrier; wherein the planar element is held exclusively by means of adhesion.

2. The substrate carrier as defined in claim 1, wherein the planar element is a semiconductor substrate.

3. The substrate carrier as defined in claim 1, wherein the substrate carrier is a pull-out finger for a planar element.

4. The substrate carrier as defined in claim 1, wherein the substrate carrier is a changer for a planar element.

5. The substrate carrier as defined in claim 1, wherein the substrate carrier is a wafer chuck for a planar element.

6. The substrate carrier as defined in claims 1, wherein the substrate carrier is an end effector for a planar element.

7. The substrate carrier as defined in claim 1, wherein the plastic support is made of an elastomer.

8. The substrate carrier as defined in claim 1, wherein the plastic support is made of a thermoplastic.

9. The substrate carrier as defined in claim 8, wherein the thermoplastic is made of a soft PVC.

10. The substrate carrier as defined in claim 1, wherein the plastic support on the substrate carrier is subdivided into several individual plastic supports, the plastic supports together forming an overall support surface which is calculated in such a way that the adhesion forces are sufficient to hold the planar element.

11. The substrate carrier as defined in claim 10, wherein the overall surface of the plastic supports for the planar element is calculated as a function of the diameter and the weight of the planar element.
